(19) United States
(12) Patent Application Publication
(10) Pub. No.: US 2025/0307644 A1
(43) Pub. Date: Oct. 2, 2025

(54) SYSTEM AND METHOD FOR DIGITAL COGNITIVE DEBIASING IN ARTIFICIAL INTELLIGENCE MODELS

(71) Applicant: MORGAN STATE UNIVERSITY, Baltimore, MD (US)

(72) Inventor: Gabriella Waters, Baltimore, MD (US)

(21) Appl. No.: 19/091,159

(22) Filed: Mar. 26, 2025

Related U.S. Application Data
(60) Provisional application No. 63/569,808, filed on Mar. 26, 2024.

(51) Int. Cl. G06N 3/092; G06F 18/21

(52) U.S. Cl. CPC G06N 3/092; G06F 18/217

(57) ABSTRACT

A method and system for detecting and mitigating bias in artificial intelligence models through bias coefficient calculation and weighted traceability analysis. The system calculates bias coefficients by computing derivatives of weights to biases for model layers, reshaping vectors to align with weight matrices, and generating polynomial factors through curve fitting. The weighted traceability implementation tracks feature influence through network layers to identify nodes and features with disproportionate impact. Based on the interaction between traceability scores and bias coefficients, the system deactivates specific nodes while preserving trained knowledge and modifies the weights of remaining nodes to reduce bias propagation. This mathematical framework enables targeted bias mitigation while maintaining model performance through polynomial functions for bias detection and gradient calculations over training epochs. The technical approach ensures bias reduction without compromising essential feature relationships or model capabilities.

### CROSS REFERENCE TO RELATED APPLICATIONS

This application is based upon and claims the benefit of U.S. Provisional Application No. 63/569,808 titled “Digital Cognitive Debiasing Method,” filed with the United States Patent & Trademark Office on Mar. 26, 2024, the specification of which is incorporated herein by reference in its entirety.

### FIELD OF THE INVENTION

The present invention relates to methods and systems for detecting and mitigating bias in artificial intelligence models through bias coefficient calculation and weighted traceability analysis. More specifically, the invention relates to techniques for calculating bias coefficients, performing weighted traceability analysis, and implementing bias mitigation in machine learning systems through mathematical approaches for tracking feature influence and quantifying disparities between demographic groups.

### BACKGROUND OF THE INVENTION

Artificial intelligence (AI) computing systems have become integral to modern computing operations, performing complex analytics on large datasets to identify patterns and generate insights that drive decision-making. These systems combine artificial intelligence with sophisticated analytics to enable accurate predictions, automate aspects of decision support, and perform various recognition and classification operations.

The development of AI systems presents unique technical challenges related to ensuring fairness and accuracy in their operation. While AI models can achieve high performance metrics, the complexity of their internal operations can make it difficult to identify potential sources of bias that may affect downstream computing systems. This technical challenge is particularly significant in mission-critical applications where decisions can have substantial real-world impacts.

Existing approaches to bias detection and mitigation face several key limitations. Current methods struggle to mathematically represent how different data points contribute to potential biases in model outputs, particularly when dealing with complex network architectures. Traditional approaches lack robust mathematical frameworks for combining fairness metrics with feature attribution scores in ways that can effectively guide bias mitigation.

A particular technical challenge exists in developing mathematical approaches for tracking feature influence through network layers while maintaining proper dimensional alignment with weight matrices. This requires sophisticated mathematical techniques for computing derivatives of weights to biases and implementing proper gradient calculations over training epochs. Existing solutions have not adequately addressed the need for a unified approach that can both detect bias signals in model weight matrices and implement targeted mitigation while preserving essential trained knowledge.

Thus, there remains a need in the art for solutions that can analyze bias both globally and locally within AI models while providing mechanisms to normalize decision-making processes. This demands sophisticated approaches for quantifying bias through mathematical frameworks and implementing corrective measures that preserve model capabilities while ensuring more equitable outcomes.

### SUMMARY OF THE INVENTION

In accordance with certain aspects of an embodiment of the invention, methods and systems are provided for detecting and mitigating bias in artificial intelligence models through novel mathematical approaches. The invention introduces a bias coefficient calculation framework that uses derivatives of weights to biases, vector reshaping, and polynomial functions to detect bias signals in model weight matrices. This enables identification of bias while preserving essential trained knowledge.

The invention implements weighted traceability to track and quantify how features influence model decisions through network layers. Through the interaction between traceability scores and bias coefficients, the system can identify nodes and features that disproportionately impact outcomes. This technical approach enables targeted bias mitigation through node deactivation and weight adjustment mechanisms that maintain model performance while reducing harmful bias propagation.

The system's mathematical framework provides a robust yet computationally efficient method for bias detection and mitigation that can be implemented across different model architectures. By combining polynomial functions for bias coefficient calculation with weighted traceability analysis and regularization techniques, the invention enables organizations to detect and address bias while preserving core model capabilities and essential feature relationships.

### BRIEF DESCRIPTION OF THE DRAWINGS

The numerous advantages of the present invention may be better understood by those skilled in the art by reference to the accompanying drawings in which:

FIG. 1 is an exemplary system architecture showing the bias coefficient calculation components.

FIG. 2 depicts a network layer structure with feature propagation paths.

FIG. 3 is a process flow diagram showing the node deactivation and weight adjustment implementation.

### DETAILED DESCRIPTION

The invention summarized above may be better understood by referring to the following description, claims, and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced items.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

Computer readable program instructions described herein can be downloaded to respective computing/processing devices from a computer readable storage medium or to an external computer or external storage device via a network, such as for example the Internet, a local area network, a wide area network and/or a wireless network. The network may comprise copper transmission cables, optical transmission fibers, wireless transmission, routers, firewalls, switches, gateway computers and/or edge servers.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server.

In accordance with certain aspects of an embodiment, the invention provides a technical approach for detecting and mitigating bias in artificial intelligence models through bias coefficient calculation and weighted traceability analysis. The system implements mathematical methods for identifying bias signals in model weight matrices while enabling targeted mitigation through node deactivation and weight adjustment.

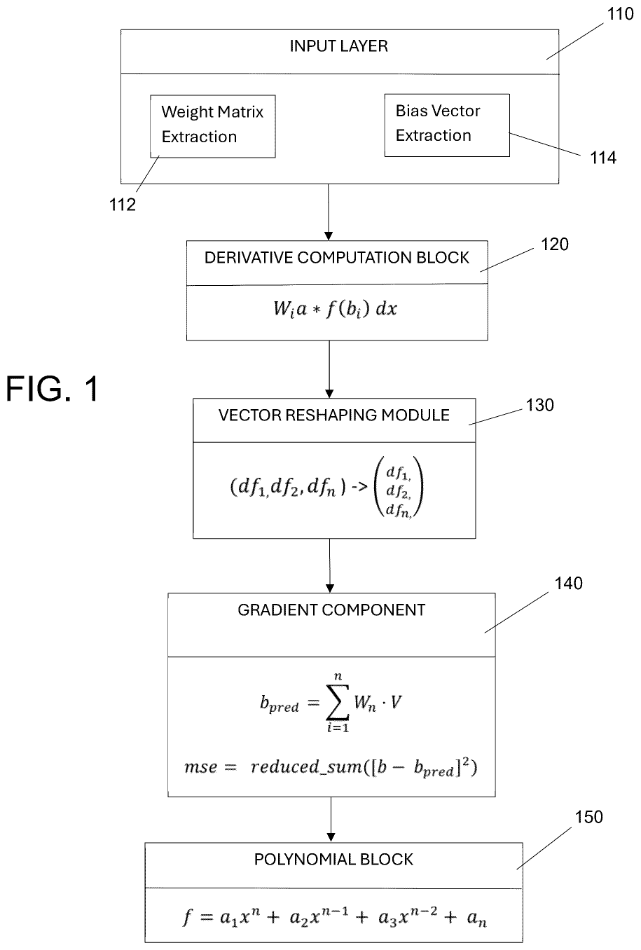

Referring now to FIG. 1, a system architecture diagram illustrates the key components for implementing bias coefficient calculation in accordance with embodiments of the invention. The system includes an Input Layer 110 positioned at the top of the diagram that contains two primary sub-components: a Weight Matrix Extraction module 112 and a Bias Vector Extraction module 114. These components are responsible for extracting the initial weight matrix and bias vector values from the trained model that will be analyzed for potential bias.

Below the Input Layer 110, the core mathematical framework consists of three key components that enable bias detection and mitigation. First, a Derivative Computation Block 120 implements the core mathematical operation for computing derivatives of weights to biases. The system calculates bias coefficients by computing derivatives of weights to biases for each model layer according to:

$${\sum }_{i = 0}^{n} {W}_{i} a * f ( {b}_{i} ) dx$$

where Wᵢa represents the weights and ƒ(bᵢ) represents the bias function for each feature in the matrix.

A Vector Reshaping Module 130 then receives the output from the Derivative Computation Block 120 and performs dimensional transformation of the vector to ensure proper alignment with the weight matrix dimensions. This reshaping operation converts the vector to a properly aligned matrix format to align with weight matrix dimensions:

$$V = ( {df}_{1 ,} {df}_{2} , {df}_{n} ) -> ( \begin{matrix}{df}_{1 ,} \\ {df}_{2 ,} \\ {df}_{n ,}\end{matrix} )$$

This reshaping ensures proper dimensional alignment for subsequent calculations.

The system implements a regularization technique during training to incorporate traceability scores and bias coefficients into the loss function. A regularization term is introduced that penalizes decisions where the traceability of potential bias indicators exceeds the threshold set by the bias coefficient. This modification of the loss function ensures that decisions where potential bias indicators exceed the bias coefficient threshold are appropriately penalized during the training process.

A Gradient Calculation Component 140 implements the gradient computation process over a specified number of training epochs for each polynomial factor. For each epoch, the system calculates gradients according to:

$${b}_{pred} = {\sum }_{i = 1}^{n} {W}_{n} \cdot V \\ m s e = reduced\_sum ( {[ b - {b}_{pred} ]}^{2} )$$

This component works towards the bottom of a wall of values in an iterative process similar to gradient descent, helping optimize the polynomial factors for accurate bias detection. This iterative refinement process ensures that gradients properly capture the relationships between weights and biases across the network layers.

Finally, a Polynomial Generation Block 150 generates the polynomial function of the form:

$$f = {a}_{1} {x}^{n} + {a}_{2} {x}^{n - 1} + {a}_{3} {x}^{n - 2} + {a}_{n}$$

This polynomial is used to compute the coefficients based on the premise that large variances in output represent biased signals in the weight matrix and bias vector.

As shown in FIG. 1, the foregoing components flow data through the system, with each successive component building upon the calculations of the previous components to ultimately generate the bias coefficient that enables targeted bias mitigation while preserving essential model functionality.

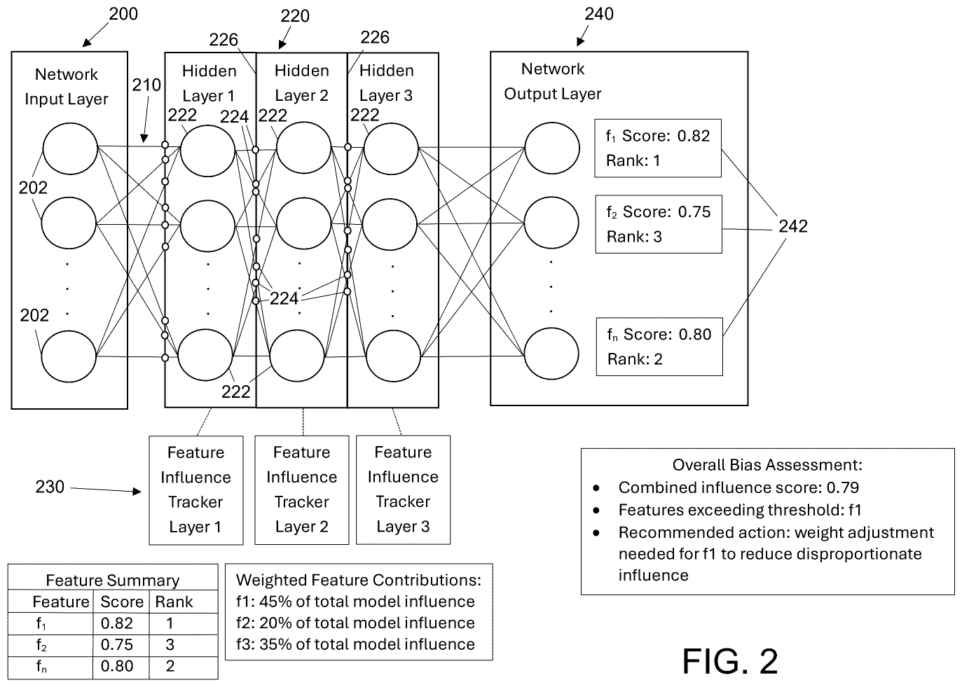

In accordance with further aspects of an embodiment of the invention and with reference generally to FIG. 2 and discussed in greater detail below, the weighted traceability implementation tracks feature influence through network layers to understand how different inputs contribute to model outputs. This enables identification of nodes and features that disproportionately impact decisions. The system accumulates feature influence by tracking and attributing the impact of each input data point through various network layers. This weighted traceability enables understanding of how different data points contribute to potential biases in model outputs.

In accordance with still further aspects of an embodiment of the invention, the mathematical framework is implemented through several coordinated processes. First and with respect to the bias detection process, during model usage the bias coefficient is incorporated into the feed-forward pass by multiplying the input value against the original neuron value in the weight matrix against the function built using the polynomial with the weight matrix values inserted for each cell.

Second, and with respect to the node deactivation process, based on the traceability scores combined with the bias coefficient, individual nodes within layers can be deactivated. This prevents bias from propagating through the network while preserving the trained information. The deactivation process preferably follows the following key steps: (i) first, based on the traceability score, the system identifies nodes that are contributing disproportionately to bias in the network; (ii) second, for identified nodes, the system evaluates whether deactivation would preserve essential model information while reducing bias propagation; and (iii) third, the bias coefficient is used as a threshold to determine which nodes should be deactivated.

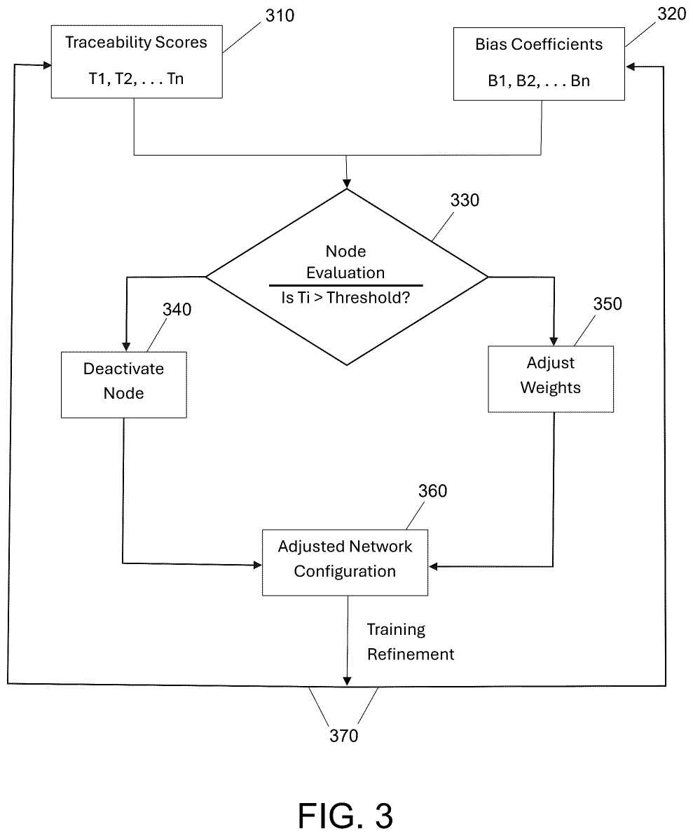

Likewise, and in accordance with still further aspects of an embodiment of the invention and with reference generally to FIG. 3 and discussed in greater detail below, during the weight adjustment process and for nodes that remain active, weights are adjusted based on the traceability scores to reduce their disproportionate impact. This adjustment can occur during the next training iteration or through direct modification of the weight matrix. Thus, after the model generates predictions, the system implements a post-prediction adjustment process based on the traceability scores of input features. This ensures that predictions are not unduly influenced by features that have been identified as sources of bias. The adjustment process analyzes the traceability scores of input features and modifies the predictions to reduce the influence of biased features.

The model retraining process involves specific steps for weight recalculation:

$${W}_{new} = {W}_{original} * f ( x )$$

where ƒ(x)=a₁xⁿ+a₂xⁿ⁻¹+a₃xⁿ⁻²+aₙ, x=original neuron value, and aᵢ=polynomial coefficients derived from bias detection. This process involves reloading the model from disk, iterating through the weight matrix, multiplying each original neuron value against the polynomial, and saving the updated model with new values to disk.

The curve fitting technique for polynomial generation implements an approach similar to gradient descent, working towards the bottom of a wall of values. This iterative process refines the polynomial factors to minimize error between predicted and actual bias values, ensuring stable and accurate polynomial generation for bias detection.

With reference again to FIG. 2, a mathematical framework diagram illustrates the network layer structure and feature influence propagation paths according to certain aspects of an embodiment of the invention. The diagram shows multiple network layers beginning with an input layer 200 containing feature nodes 202 (f1, f2, . . . fn) that represent the initial features being analyzed for bias. Each feature node connects to the subsequent hidden layers 220 through influence propagation paths 210.

The hidden layers 220 each contain neural nodes 222 with associated Feature Influence Tracker 230 components that monitor and accumulate the influence scores of features as they propagate through the network. Cumulative scoring indicators 224 positioned at layer junctions 226 provide quantitative measures of feature influence at each stage of propagation. The connection paths between layers demonstrate how feature influence flows through the network architecture, preferably with the width of paths indicating relative influence strength.

The output layer 240 displays aggregated traceability scores 242 that represent the final accumulated influence of each feature through the complete network path. These scores are crucial for identifying features that may be contributing disproportionately to biased outcomes and informing subsequent bias mitigation steps through node deactivation or weight adjustment. Preferably, a Feature Summary display is generated to provide each feature's aggregated traceability score, its influence rank among all features, and its contribution to the overall total model influence, along with the overall bias assessment for all features.

Further and with reference to FIG. 3, a process flow diagram illustrates the implementation of node deactivation and weight adjustment operations. The diagram begins with parallel input processing of traceability scores 310 (T1, T2, . . . . Tn) and bias coefficients 320 (B1, B2, . . . . Bn). These inputs feed into a Node Evaluation decision component 330 that determines whether individual nodes exceed defined bias thresholds.

For nodes that exceed thresholds, the left path shows the deactivation process 340 that removes biased nodes from the network while preserving essential trained knowledge. When the Node Evaluation component identifies nodes exceeding defined bias thresholds based on their traceability scores and bias coefficients, the system may surgically remove the biased nodes while ensuring essential model functionality is preserved. In this regard, when a node is selected for removal, the system preferably first evaluates the node's connections to ensure deactivation will not result in critical information loss. The deactivation process may proceed by: (i) identifying all input and output connections to the biased node; (ii) calculating compensatory weight adjustments for remaining connected nodes; (iii) redistributing the node's learned information across the remaining network connections; and (iv) verifying that essential feature relationships are maintained. The node removal process preferably works in concert with the weight adjustment mechanism, such that when nodes are deactivated, the weights of remaining active nodes are recalculated according to the polynomial function discussed above to ensure the network maintains its trained capabilities while reducing bias propagation.

Likewise, for nodes that remain active, the right path demonstrates the weight modification process 350 according to the formula

$${W}_{new} = {W}_{original} * f ( x )$$

where ƒ(x) represents the polynomial derived from bias detection.

The process culminates in an Adjusted Network Configuration output 360 that reflects the modified network structure with deactivated nodes and adjusted weights. Feedback paths 370 enable iterative training refinement by allowing the adjusted configuration to be validated and further refined through additional training cycles. This iterative approach ensures that bias mitigation efforts maintain model performance while reducing harmful bias propagation.

The system thus maintains model performance through (i) ensuring deactivated nodes do not result in information loss, (ii) allowing retraining with adjusted weights when needed, and (iii) using the bias coefficient to “filter out” harmful bias while preserving essential feature relationships.

The system preferably implements several mechanisms to validate bias mitigation effectiveness. First, the system compares model outputs before and after mitigation to verify preserved functionality. Second, the system calculates bias reduction metrics to quantify improvement. Third, the system monitors stability across different demographic groups to ensure fairness.

This technical approach enables targeted bias reduction while maintaining model performance and essential feature relationships.

Systems and methods configured in accordance with at least certain aspects of the invention may provide a number of advantages over prior art systems and methods, for example through its core technical approach to bias detection and mitigation. Particularly, systems and methods configured in accordance with aspects of the invention may offer efficient bias detection, as the bias coefficient calculation provides a mathematically robust yet computationally efficient method for detecting bias signals in model weight matrices. By computing derivatives of weights to biases and implementing polynomial functions, the system can identify bias without requiring extensive computational resources.

Further, systems and methods configured in accordance with aspects of the invention may assist in preservation of model knowledge, as the weighted traceability implementation enables targeted bias mitigation while preserving the model's essential trained knowledge. By tracking feature influence through the network, the system can identify and address bias without compromising core model capabilities.

Still further, systems and methods configured in accordance with aspects of the invention may offer flexible deployment, as the system's mathematical framework for bias coefficient calculation and node deactivation can be implemented across different model architectures. This flexibility allows organizations to deploy bias detection without requiring fundamental changes to existing AI systems.

Even further, systems and methods configured in accordance with aspects of the invention may offer actionable insights through the interaction between traceability scores and bias coefficients, providing clear guidance for bias mitigation through node deactivation and weight adjustment. This enables practical steps for improving model fairness.

Still yet further, systems and methods configured in accordance with aspects of the invention may exhibit maintainable performance, as the technical approach ensures that bias mitigation efforts do not significantly impact model performance. By using polynomial functions to guide node deactivation and weight adjustments, the system maintains essential feature relationships while reducing harmful bias.

Among the possible applications, digital cognitive debiasing can be used by organizations to ensure their AI algorithms adhere to fairness standards. Additionally, regulatory bodies can use the coefficient as a benchmark for AI fairness.

The foregoing debiasing system was applied to a dataset entitled COMPAS, in which the criminal justice system was examined to understand, based on extensive criteria like age, past crimes, categories, prior convictions, whether there the result exhibited biases in sentencing, for example.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A method for bias detection and mitigation in machine learning models, comprising:
calculating a bias coefficient based on weight and bias values from a model;
determining feature influence through the model;
identifying features having disproportionate impact; and
modifying the model to reduce identified bias while preserving model functionality.

2. The method of claim 1, wherein calculating the bias coefficient comprises:
computing derivatives of weights to biases according to
$${\sum }_{i = 0}^{n} {W}_{i} a * f ( {b}_{i} ) dx ;$$
reshaping vectors to align with weight matrix dimensions; and
generating polynomial factors through curve fitting.

3. The method of claim 1, wherein determining feature influence comprises:
tracking feature propagation through model layers; and
accumulating influence scores at each layer.

4. The method of claim 1, wherein modifying the model comprises deactivating nodes based on influence scores; and
adjusting weights of remaining nodes.

5. The method of claim 1, wherein calculating the bias coefficient comprises deriving a polynomial of the form
$$f = {a}_{1} {x}^{n} + {a}_{2} {x}^{n - 1} + {a}_{3} {x}^{n - 2} + {a}_{n} .$$

6. The method of claim 1, wherein modifying the model comprises preserving essential trained knowledge during bias reduction.

7. The method of claim 1, further comprising validating bias mitigation by monitoring model performance.

8. The method of claim 1, wherein the bias coefficient is calculated through iterative refinement of polynomial factors.

9. The method of claim 1, wherein calculating the bias coefficient further comprises implementing a regularization term in the model's loss function to penalize decisions where feature traceability exceeds defined bias thresholds.

10. The method of claim 1, further comprising performing post-prediction adjustments based on feature traceability scores to reduce the influence of biased features on final predictions.

11. The method of claim 1, wherein modifying the model comprises implementing an iterative weight recalculation process that multiplies original neuron values against derived polynomials to generate adjusted weights.

12. A computer-implemented method for bias mitigation in neural networks, comprising:
analyzing weight and bias relationships across network layers;
tracking feature influence propagation;
identifying bias indicators based on feature influence patterns;
modifying network parameters to reduce identified bias; and
preserving trained model knowledge during modification.

13. The method of claim 12, wherein analyzing weight and bias relationships comprises:
computing derivatives according to
$${\sum }_{i = 0}^{n} {W}_{i} a * f ( {b}_{i} ) dx ;$$
and
generating polynomial factors through curve fitting.

14. The method of claim 12, wherein tracking feature influence comprises accumulating influence scores at each network layer.

15. The method of claim 12, wherein modifying network parameters comprises:
deactivating nodes based on influence scores; and
adjusting weights of remaining nodes.

16. The method of claim 12, further comprising validating bias reduction while maintaining performance.

17. The method of claim 12, wherein modifying parameters comprises adjusting weights during training iterations.
